(19) United States
(12) Patent Application Publication
(10) Pub. No.: US 2020/0026747 A1
(43) Pub. Date: Jan. 23, 2020

(54) SYSTEMS AND METHODS FOR CHOLESKY DECOMPOSITION

(71) Applicants: Hong Cheng, Beijing (CN); Xu Zhang, Beijing (CN); Richard Maiden, Mission Viejo, CA (US); Long Jiang, Beijing (CN)

(72) Inventors: Hong Cheng, Beijing (CN); Xu Zhang, Beijing (CN); Richard Maiden, Mission Viejo, CA (US); Long Jiang, Beijing (CN)

(21) Appl. No.: 16/586,669

(22) Filed: Sep. 27, 2019

(51) Int. Cl. G06F 17/16

(52) U.S. Cl. CPC G06F 17/16

(57) ABSTRACT

A system is provided, a circuitry comprising a plurality of processing elements (PEs) and configured to receive as input entries of a Hermitian positive-definite matrix A. The circuitry is also configured to Cholesky decompose the matrix A by deriving an intermediate numerator for at least one of the entries. The circuitry is additionally configured to calculate a square root for the intermediate numerator and to derive as an output an entry of a lower triangular matrix L based on the square root, wherein A=LL*, and wherein L* is a conjugate transpose of the lower triangular matrix L.

### BACKGROUND

The present disclosure generally relates to systems and methods for decompositions, and more specifically, to systems and methods for Cholesky decompositions.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In certain matrix operations, such as a matrix decomposition, the matrix is divided or factorized into a product of multiple matrices. For example, when solving a system of linear equations Ax=b, a Lower-Upper (LU) decomposition may factorize a matrix A into a lower triangular matrix L and an upper triangular matrix U. L(Ux)=b and/or Ux=L⁻¹b may then be used to result in fewer operations (e.g., additions, multiplications) when solving Ax=b. Cholesky decomposition may also be used to solve Ax=b, for example, if A is a symmetric and positive definite matrix. The Cholesky decomposition may find A=LL* where L is a lower triangular matrix with real and positive diagonal entries, and L* is a conjugate transpose of L. Forward substitution may then be used to solve for y via Ly=b, and back substitution may be used to solve for x via L*x=y. It may be advantageous to provide for systems and methods that more efficiently factorize A via Cholesky decomposition.

### BRIEF DESCRIPTION OF THE DRAWINGS

FIG. 1 is a block diagram of a data processing system including one or more processors having a Cholesky decomposition system, in accordance with an embodiment of the present disclosure;

FIG. 2 is a block diagram depicting an embodiment of certain Cholesky decomposition steps as applied to a 2×2 Hermitian positive-definite matrix A;

FIG. 3 is a block diagram depicting an embodiment of certain factorization steps applied for Cholesky decomposition using parallel numerator computations;

FIG. 4 is a flowchart of an embodiment of a process suitable for applying a modified Cholesky decomposition to provide for computational parallelism;

FIG. 5 is a block diagram illustrating a 4×4 Hermitian positive-definite matrix A as it undergoes a transformation into a lower triangular matrix L;

FIG. 6 is a block diagram depicting further transformations of an embodiment of the matrix A of FIG. 5;

FIG. 7 is block diagram of an embodiment of a matrix illustrating a transformation into a lower triangular matrix L of the matrix A of FIG. 5 using certain square root results;

FIG. 8 is a schematic diagram illustrating an embodiment of a complex-valued multiply-accumulate (CMAC) cell array suitable for implementing certain Cholesky decomposition techniques;

FIG. 9 is a schematic diagram of an embodiment of the CMAC cell array of FIG. 8 illustrating the use of diagonals for processing data through various iterations;

FIG. 10 is a block diagram of an embodiment of a process flow that may be used to iterate through processing elements (PEs) in a CMAC cell array;

FIG. 11 is a schematic diagram illustrating and embodiment of a CMAC cell array showing outputs from one edge of the array being used as inputs into other systems;

FIG. 12 is a schematic diagram showing an embodiment of a CMAC cell array where output data from a subset of PEs in the CMAC cell array is representative of a first output iteration through the CMAC cell array;

FIG. 13 is a schematic diagram showing an embodiment of a CMAC cell array where a output data from a subset of PEs in the CMAC cell array is representative of a second output iteration through the CMAC cell array; and

FIG. 14 is a schematic diagram showing an embodiment of a CMAC cell array where output data from a subset of PEs in the CMAC cell array is representative of an nth output iteration through the CMAC cell array.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In certain operations, Cholesky decomposition techniques may such be applied to solve for a variety of matrix-based problems where a matrix A may be a Hermitian positive-definite matrix. Accordingly, the matrix A may be decomposed into A=LL* where L is a lower triangular matrix with real and positive diagonal entries, and where L* is a conjugate transpose of L. A linear equation in the form Ax=b may then be more easily solved, for example, when compared to solutions arrived at via Lower-Upper (LU) decompositions. For example, one can solve Ax=b by first deriving the Cholesky decomposition A=LL*. Forward substitution may then be used to solve for y via Ly=b and back substitution may be used to solve for x via L*x=y. Accordingly, a variety of problems in digital signal processing (DSP), Monte Carlo simulations, Kalman filters, wireless communication, machine learning, and so on, may apply Cholesky decomposition. For instance, Linear Minimum Mean Squared Error (LMMSE) and Principle Component Analysis (PCA) both may use Cholesky decomposition.

Applications that include Cholesky decomposition may include computationally intensive derivations, and may also include more stringent throughput and timing delay requirements. For example, a data dependency in a traditional approach for Cholesky decomposition may result in reduced parallelism for computing purposes and leave certain processing resources underutilized, especially when implemented in systems such as field programmable gate arrays (FPGAs), application specific integrated circuits (ASICs), and the like. In one example of the traditional approach, each entry Lᵢⱼ (i≥j) may only be calculated after diagonal entries Lₖₖ (k≤i) and non-diagonal entries Lₘₙ(m=i, j; n<i) are derived first.

The techniques described herein provide for a hardware architecture and for processes that may compute certain numerators and denominators individually, minimizing or eliminating dependencies. For example, a data dependency between square root calculations of diagonal matrix elements as well as related multiplication and addition operations, may now be minimized or eliminated. A novel triangular systolic array (TSA) architecture which may include complex multiplier-accumulators (CMACs) cells may be designed for use with the techniques described herein. The TSA architecture may enable enhanced parallelism for certain operations, thus improving speed and/or efficiency of Cholesky decompositions. Additionally, the TSA architecture may be reused for other non-Cholesky problem solving derivations, such as for back substitution computations, matrix-matrix multiplications, and/or matrix-vector multiplications.

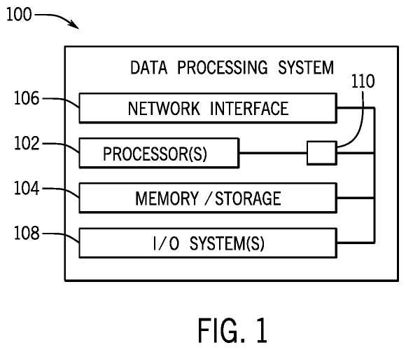

With the foregoing in mind, FIG. 1 is a block diagram of a data processing system 100 including one or more processor(s) 102, in accordance with an embodiment of the present disclosure. The data processing system 100 may include more or fewer components (e.g., electronic display, user interface structures, application specific integrated circuits (ASICs)) than shown. The data processing system 100 may execute certain code or computer instructions via the or more processors 102, such as an INTEL® 10^{th} generation processor (e.g., Ice Lake processor) that may manage data processing requests for the data processing system 100 (e.g., to perform machine learning, digital signal processing, video processing, voice recognition, image recognition, data compression, database search ranking, bioinformatics, network security pattern identification, spatial navigation, or the like).

The processor(s) 102 may communicate with the memory and/or storage circuitry 104, which may be a tangible, non-transitory, machine-readable-medium, such as random-access memory (RAM), read-only memory (ROM), one or more hard drives, flash memory, or any other suitable optical, magnetic or solid-state storage medium. The memory and/or storage circuitry 104 may hold data to be processed by the data processing system 100, such as processor-executable control software, configuration software, system parameters, configuration data, etc.

The data processing system 100 may also include a network interface 106 that allows the data processing system 100 to communicate with other electronic devices. In some embodiments, the data processing system 100 may be part of a data center that processes a variety of different requests. For instance, the data processing system 100 may receive a data processing request via the network interface 106 to perform machine learning, video processing, voice recognition, image recognition, data compression, database search ranking, bioinformatics, network security pattern identification, spatial navigation, or some other specialized task. The data processing system 100 may also include one or more input/output systems 108, such as display devices (e.g., computer monitors), keyboards, mice, speakers, voice input devices, and so on, useful for entering and/or displaying information.

In the depicted embodiment, the processor 102 may be communicatively coupled to or include a Cholesky decomposition system 110. In use, the Cholesky decomposition system 110 may receive as input one or more matrices, such as Hermitian, positive-definite matrices A, and then decompose each matrix A into L and L* where L is a lower triangular matrix with real and positive diagonal entries, and L* is a conjugate transpose of L. In a traditional approach, L may be computed via Equation (1) and Equation (2).

$$\begin{matrix}{L}_{ii} = \sqrt{{A}_{ii} - {\sum }_{k = 1}^{i - 1} {L}_{ik} {L}_{ik}^{*}} \\ i = 1 , 2 , … , n & Equation ( 1 ) \\ {L}_{ij} = \frac{1}{{L}_{jj}} ( {A}_{ij} - {\sum }_{k = 1}^{j - 1} {L}_{ik} {L}_{jk}^{*} ) \\ i = j + 1 , j + 2 , … , n & Equation ( 2 )\end{matrix}$$

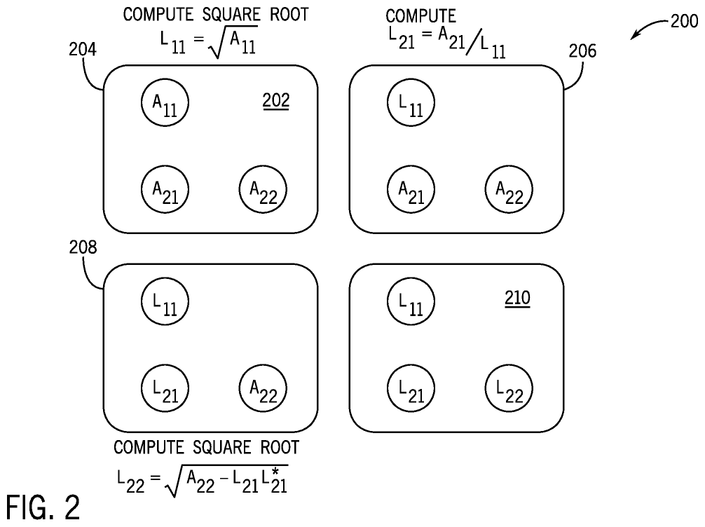

There exists a dependency between the square root calculation in Equation (1) used to compute Lᵢᵢ and other operations in Equation (2) used to compute Lₘₙ (m>n, m≥i). Only when the former square root calculation is complete can the latter part of the calculation start. The decomposition via Equation (1) and Equation (2) is thus tightly coupled as the index i goes from 1 to n. For example, the tight coupling may result in extra operations to complete the Cholesky decomposition, as shown in FIG. 2.

FIG. 2 is a block diagram depicting an embodiment of factorization steps 200 via Cholesky decomposition as applied to a 2×2 Hermitian positive-definite matrix A 202. The A matrix 202 may be factored by converting elements A₁₁, A₂₁, and A₂₂ into L₁₁, L₂₁, and L₂₂, respectively. In the depicted embodiment, a step 204 may first compute L₁₁=\sqrt{A₁₁}. Then, a step 206 may use the computed L₁₁ value to compute L₂₁=A₂₁/L₁₁. Once L₂₁ is computed, a third step 208 may be used to compute L₂₂=\sqrt{A₂₂−L₂₁L*₂₁} to result in matrix L 210, the lower triangular matrix of matrix A 202. As illustrated, completion of the step 208 depended on the step 206 being completed. Likewise, completion of the step 206 depended on the step 204 being completed.

The techniques described herein may improve decoupling of certain computations and thus increase parallelism and resource utilization. In one embodiment, certain L₂₂ may be computed as a fraction. For example, an Equation (3) may be used to derive L₂₂ based on A₁₁, A₂₁, A₂₂, and L₁₁=\sqrt{A₁₁} values.

$${L}_{22} = \sqrt{{A}_{22} - {L}_{21} {L}_{21}^{*}} = \sqrt{{A}_{22} - {A}_{21} {A}_{21}^{*} / {L}_{11}^{2}} = \frac{\sqrt{{A}_{11} {A}_{22} - {A}_{21} {A}_{21}^{*}}}{\sqrt{{A}_{11}}} \qquad Equation ( 3 )$$

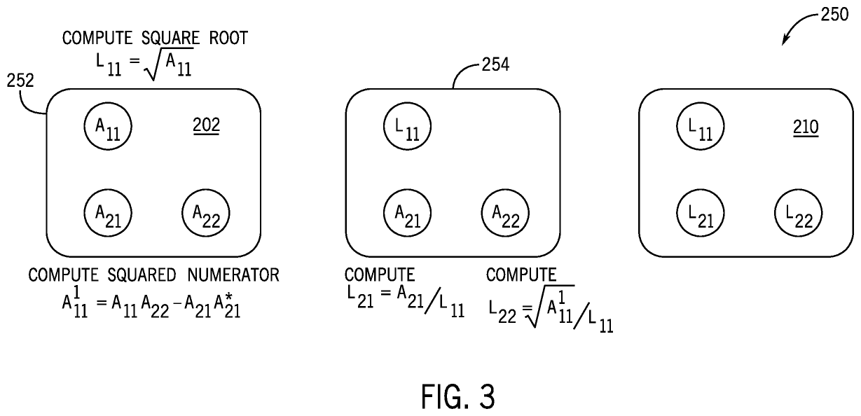

As shown in Equation (3), a final numerator does not depend on L₁₁. Therefore, L₁₁ and the numerator for L₂₂ may be computed in parallel, as shown in FIG. 3. More specifically, FIG. 3 is a block diagram depicting an embodiment of factorization steps 250 via Cholesky decomposition using parallel numerator computations. In the depicted embodiment, the 2×2 matrix A 202 may first be processed via step 252. Step 252 includes parallel processing to compute L₁₁ and A₁₁¹ where superscript i denotes the intermediate numerator of the entry in a deflated matrix that is iteratively updated by first i columns. Matrix deflation or deflating refers to the dimension of a submatrix to be processed being reduced as a column goes from left to right. The original indices of an entry according to the input matrix is the sum of present superscript and subscript. As shown in FIG. 3, the step 252 includes computing L₁₁=\sqrt{A₁₁} and additionally computing A₁₁¹=A₁₁A₂₂−A₂₁A*₂₁. Step 254 may then use the previously computed L₁₁ and A₁₁¹ to derive L₂₁=A₂₁/L₁₁ and L₂₂=\sqrt{A₁₁¹}/L₁₁. Accordingly, the matrix L 210 may be computed in two steps, as opposed to the three steps shown in FIG. 2.

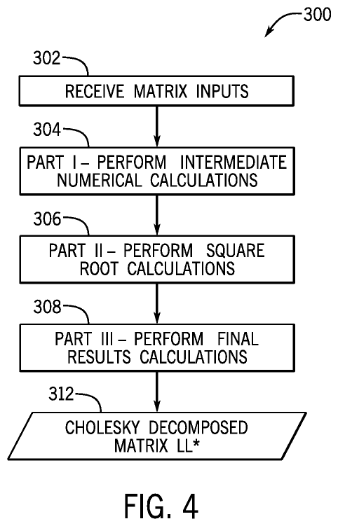

A more efficient parallel computing process may thus be derived, as shown in FIG. 4. More specifically, FIG. 4 is a flowchart of an embodiment of a process 300 suitable for applying a modified Cholesky decomposition to provide for parallelism and to improve resource (e.g., parallel computing resource) use. In the depicted embodiment, the process 300 may first receive (block 302) certain input data, such as one or more matrices A. As mentioned above, each matrix A may be a Hermitian, positive-definite matrix. The process 300 may then perform (block 304) in Part I certain intermedia numerical calculations. For example, let A_{i,j}^{k} denote an intermediate numerator of an entry in a deflated matrix that is updated by first k columns. If A_{i,j}^{k} corresponds to intended final output L_{m,n}, this indicates m=i+k, and n=j+k. A_{i,j}⁰ and A_{i,j} of input matrix are equivalent. That is, A_{i,j}^{k} is the numerator of entry at row i and column j of deflated matrix in k-th iteration and corresponds to the entry A_{i+k,j+k} in original matrix A. Let A_{1,1}⁻¹=1. Part I (block 304) may then compute as follows:

```
for k = 0 to n − 2 do
    for j = 2 to n − k do
        for i = j to n − k do
            A_{i-1,j-1}^{k+1} ← A_{1,1}^{k}A_{i,j}^{k} − A_{i,1}^{k}A_{j,1}^{k}*
        end for
    end for
end for
```

The process 300 may also perform (block 306) Part II square root calculations of A_{1,1}^{k} (k=0, . . . , n−1). The process 300 may additionally perform (block 308) Part III final result calculations as follows:

```
for j = 1 to n do
    L_{j,j} ← \sqrt{A_{1,1}^{j-1}}/πₖ₌₀^{j-2}\sqrt{A_{1,1}^{k}}
    for i = j + 1 to n do
        L_{i,j} ← A_{i-j+1,1}^{j-1}/πₖ₌₀^{j-1}\sqrt{A_{1,1}^{k}}
    end for
end for
```

Accordingly, the process may then result in a Cholesky decomposed matrix 312 having L as a lower triangular matrix with real and positive diagonal entries, and L* as a conjugate transpose of L.

In the depicted process 300, most of the computations for the Cholesky decomposition may occur Part I (block 304). Part I may not depend on Part II and Part III. Accordingly, the computations for Part I (block 304) may be pipelined, for example, via a systolic array system further described in the figures below. Further, Parts I, II, and III may computed in parallel. For example, when Part II outputs \sqrt{A₁₁^{k}}, the square root has already been divided into intermediate numerators A_{i,j}^{p}, p≥k, i≥j. Accordingly, operations in Parts I, II, and III may be carried out simultaneously.

Advantageously, a time for dividing \sqrt{A₁₁^{k}} into intermediate numerators may be flexible. In one embodiment, the time for dividing \sqrt{A₁₁^{k}} into intermediate numerators may take place during the computations (block 304) of Part I or after the completion of Part I. However, early division and substituting quotients for intermediate numerators may improve numerical stability and also improve hardware parallelism. In Part II (block 306), we may compute a reciprocal square root (1/√) instead of the depicted square root (√). When using the reciprocal square root in Part II (block 306) the division operation in Part III becomes a multiplication operation. For floating point numbers, certain algorithm may compute 1/√ more efficiently than V and then reciprocate the result, thus resulting in even more efficient process 300 computations.

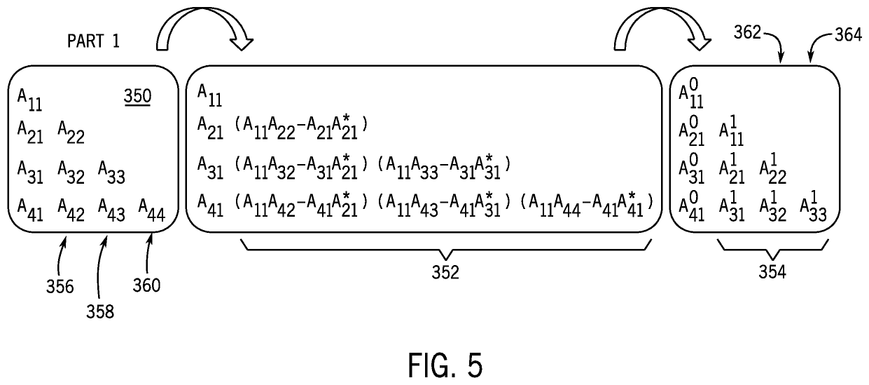

It may be beneficial to illustrate an example application of the process 300 to a 4×4 matrix A. For example, FIG. 5, is a block diagram illustrating a 4×4 matrix A 350 as it undergoes a transformation into a lower triangular matrix L. As illustrated the, matrix 350 may undergo a transformation of section 352 based on A_{i-1,j-1}^{k+1}←A_{1,1}^{k}A_{i,j}^{k}−A_{i,1}^{k}A_{j,1}^{r*} into a first deflated matrix 354. Accordingly, a first column 356 of the matrix A 350 may have entry A₂₂ processed via (A₁₁A₂₂−A₂₁A₂₁*) to derive A₁₁¹, entry A₃₂ processed via (A₁₁A₃₂−A₃₁A₂₁*) to derive A₂₁¹, and entry A₄₂ may be processed via (A₁₁A₄₂−A₄₁A₂₁*) to derive A₃₁¹. Moving left to right, a second column 358 may have entry A₃₃ processed via (A₁₁A₃₃−A₃₁A₃₁*) to derive A₂₂¹, and entry A₄₃ process via (A₁₁A₄₃−A₄₁A₃₁*) to derive A₃₂¹. A third column 360 may then have entry A₄₄ processed via (A₁₁A₄₄−A₄₁A₄₁*) to derive A₃₃¹.

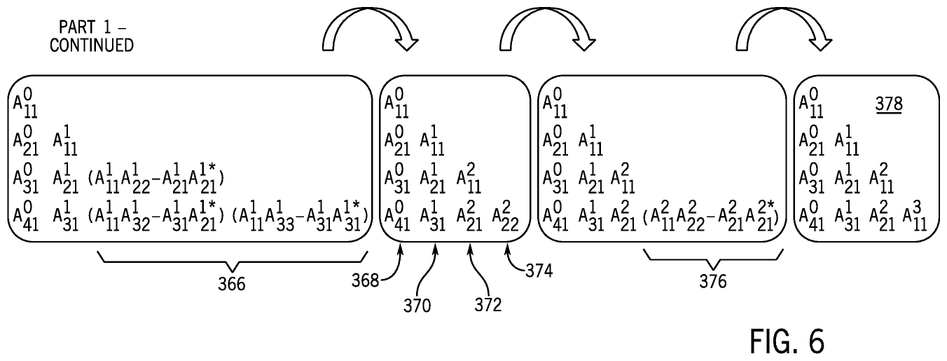

As indicated in the “for” loops in Part I (block 304), processing may then move to columns 362 and 364, for example, column 362 is processed so that entry A₂₂¹ is processed via (A₁₁¹A₂₁¹−A₂₁¹A₂₁^{1*}) to derive A₁₁², and so that entry A₃₂¹ is processed via (A₁₁¹A₃₂¹−A₃₁¹A₂₁^{1*}) to derive A₂₁² shown in FIG. 6. More specifically, the figure is a block diagram depicting further transformations of matrix A 350 as section 366 corresponding to second deflated matrix having columns 362, 364, is transformed via A_{i-1,j-1}^{k+1}←A_{1,1}^{k}A_{i,j}^{k}−A_{i,1}^{k}A_{j,1}^{k*}. As shown, column 364 is also transformed by processing entry A₃₃¹ via (A₁₁¹A₃₃¹−A₃₁¹A₃₁^{1*}) to derive A₂₂².

As shown, in FIG. 6, columns 368, 370, and 372 have already been processed via Part I (block 304) and this processing may be shown via a superscript value i for each entry in a column matching the column's number (e.g. . . . , 0, 1, 2). Only column 374 remain to be processed via Part I (block 304). Accordingly, section 376 may be used to process column 374. More specifically, entry A₂₂² may be processed via (A₁₁²A₂₂²−A₂₁²A₂₁^{2*}) to derive A₁₁³. A Part I result matrix 378 is then shown. The matrix 378 may then be processed via Part II (block 308) to derive square roots for all ending entries (e.g., diagonal entries) of matrix 378, e.g., \sqrt{A₁₁⁰}, \sqrt{A₁₁¹}, \sqrt{A₁₁²}, and \sqrt{A₁₁³}.

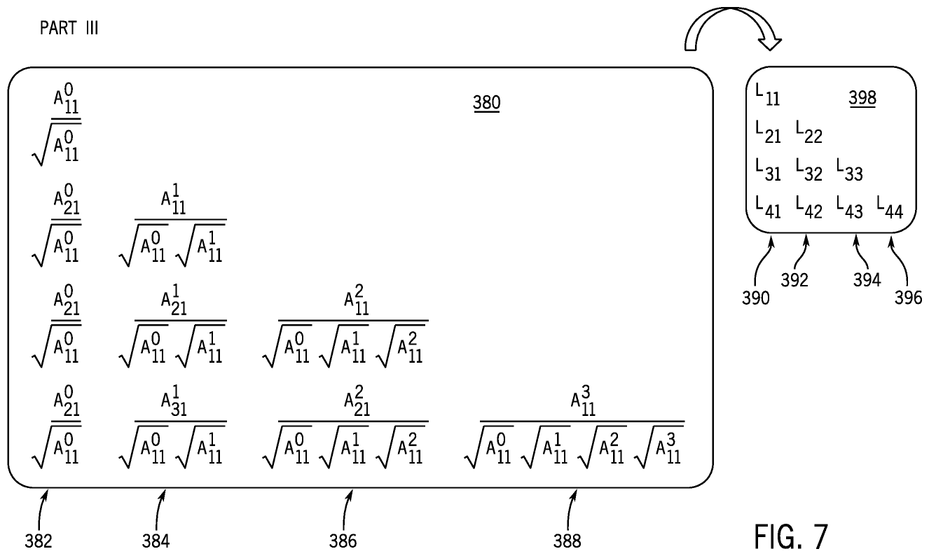

Square root results of Part II (block 308) may then be used in Part III (block 310) final results calculations, as shown in FIG. 7. More specifically, FIG. 7 is block diagram of an embodiment of matrix 380 illustrating a transformation of matrix 376 using the square root results of Part II (block 308), e.g., \sqrt{A₁₁⁰}, \sqrt{A₁₁¹}, \sqrt{A₁₁²}, and \sqrt{A₁₁³}, being disposed as denominators for the entries of matrix 376 as indicated by the derivations L_{j,j}←\sqrt{A_{1,1}^{j-1}}/Πₖ₌₀^{j-2}\sqrt{A_{1,1}^{k}} and L_{i,j}←A_{i-j+1,1}^{j-1}/Πₖ₌₀^{j-1}\sqrt{A_{1,1}^{k}} of Part III (block 310).

Each column 382, 384, 386, and 388 may then be transformed into columns 390,392, 394, and 396, respectively, included in an L matrix 398. The L matrix 398 is the lower triangular matrix of matrix A 350 shown in FIG. 5. A L* matrix may then be arrived at by first transposing and then conjugating the L matrix 398. For computational complexity, process 300 has only n−1 more real multiplications than a traditional non-parallelized approach. The additional real multiplications are found in multiplying the square root in Part II (block 306) of one iteration onto those of previous iterations. Overhead may be negligible. For instance, complexity may increase by 0.9% for an 8×8 matrix when compared to a 4×4 matrix.

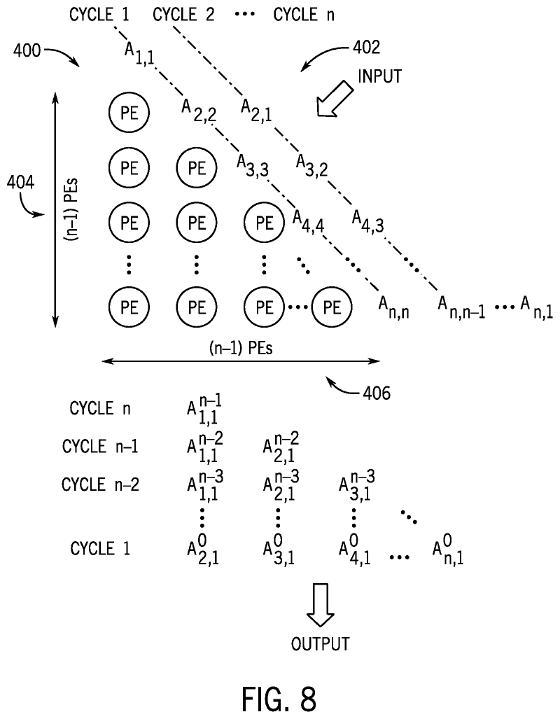

In some embodiments, the process 300 or portions of the process 300 may be implemented via a complex-valued multiply-accumulate (CMAC) cell array, as illustrated in FIG. 8. More specifically, FIG. 8 is a schematic diagram illustrating an embodiment of a CMAC cell array 400 suitable for implementing certain Cholesky decomposition techniques, including the techniques described herein. In the depicted embodiment, the CMAC cell array 400 is arranged in a triangular shape with sides or edges 402, 404, and 406. In the depicted embodiments, each side 402, 404, and 406 includes (n−1) processing elements (PEs) where n is a dimension of an n x n input matrix A. That is, if inputs size for arrays A is to be n×n then the CMAC cell array 400 includes (n−1) processing elements on each side 402, 404, and 406. Because the number of cells (e.g., PE cells) in each side 402, 404, and 406 of the depicted embodiment are equal, the depicted CMAC cell array 400 is an isosceles triangle CMAC cell array.

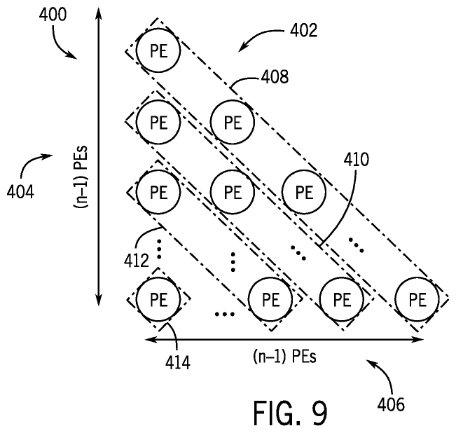

The CMAC cell 400 array, in one embodiment, is a systolic array. In systolic arrays, such as in the CMAC cell array 400, the PEs are included in a homogenous network of tightly coupled data processing units where each PE independently computes a result (e.g., partial result) of a function of the data received from its upstream neighbors, the PE may then store the result within itself and then may pass the result downstream to other PEs. If the input matrix A is n×n, a first iteration through the CMAC cell array 400 may generate a deflated lower triangular matrix of (n−1)×(n−1), whose entries are A_{i,j}¹, (1≤j≤n−1,j≤i≤n−1). There are n(n−1)/2 entries in the deflated matrix after the first iteration. Two CMAC operations are used to compute each entry, e.g., A_{i-1,j-1}^{k+1}←A_{1,1}^{k}A_{i,j}^{k}−A_{i,1}^{k}A_{j,1}^{k*}. Therefore the computational complexity in terms of CMAC in the first iteration is n(n−1). In the depicted embodiment, the n−1 PEs in the edge or boundary 402 of systolic array are used exclusively for the first iteration. For these PEs, the number of cycles to input data of one matrix is n cycles (largest number of cycles in order to be fully pipelined). The total number of CMACs that these n−1 PEs may provide is n(n−1) which is the exactly the same as the number of CMACs required in the first iteration. Full utilization of the PEs may thus be achieved. After each subsequent iteration, the dimension of a subsequent deflated matrix is decreased by one. For k-th (1≤k≤n−1) iteration, n−k PEs are assigned to the iteration, and each of these PE takes n−k+1 cycles for each input matrix. FIG. 8 also illustrates a series of inputs through cycle 1 to cycle n and corresponding outputs through edges 402 and 406, respectively. It is to be noted that inputs are shown as flowing through edge 402 and outputs exiting through edge 406. However, due to the symmetric nature of the cell array 400, inputs may flow through any edge 402, 404, or 406, and exit through any other edge. An example of allocation diagonal PEs to each iteration is demonstrated in FIG. 9.

More specifically, FIG. 9 is a schematic diagram of an embodiment of the CMAC cell array 400 illustrating the use of diagonals 408, 410, 412, and 414 for processing data through various iterations. In the illustrated embodiment, diagonal 408 processes iteration 1, having (n−1) PEs, and n cycles per matrix. The diagonal 410 processes for iteration 2, having (n−2) PEs, and (n−1) cycles per matrix. The diagonal 412 processes for iteration 3, having (n−3) PEs, and (n−2) cycles per matrix. The final diagonal 414 is shown as processing iteration (n−1) and as having a single PE, with 2 cycles per matrix.

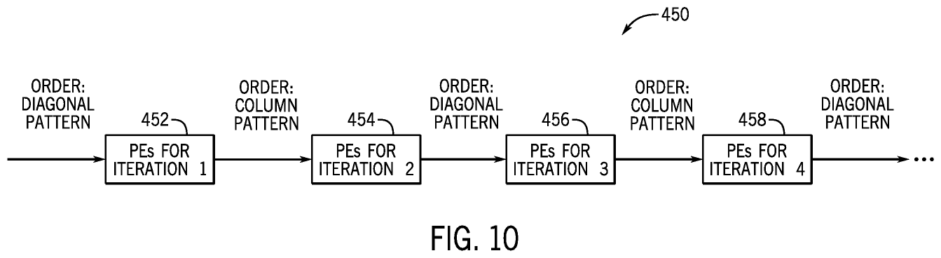

For PEs used for one iteration, the order may be different for input and output entries, as shown in FIG. 10. As illustrated, FIG. 10 is a block diagram of an embodiment of a process flow 450 that may be used to iterate through the PEs in the CMAC cell array 400. In the illustrated embodiment, there may be two order patterns for the PEs. One order may be a diagonal pattern, and another order may be a column pattern. The diagonal pattern refers to entries of a main diagonal appearing first in the processing sequence, and then the entries of the diagonal next to the main diagonal appear second in the processing sequence, and so on. The column pattern refers to entries being processed via the columns, for example, via column 1, then via column 1 and 2, then via column 1, 2, and 3, and so on. All entries of the lower triangular matrix are listed in a column-first order. The order of input and output of an iteration flips between these two patterns. For instance, if the order of input data is diagonal pattern, the order of output data is column pattern, and vice versa, as shown.

For example, a first order 452 may be a diagonal pattern order, thus processing data via the main diagonal (e.g., edge 402). The next iteration 454 may then be column pattern order, thus processing via the first column in the CMAC cell array 400. The following iteration 456 may the flip back to diagonal order, thus processing via a second diagonal of the CMAC cell array 400. The subsequent iteration may then flip back to column, order, thus processing via columns 1 and 2 of the CMAC cell array 400, and so on. By providing for a systolic array, such as the CMAC cell array 400, the techniques described herein may more efficiently and rapidly process matrix data, for example, to result in a Cholesky decomposition of a matrix A.

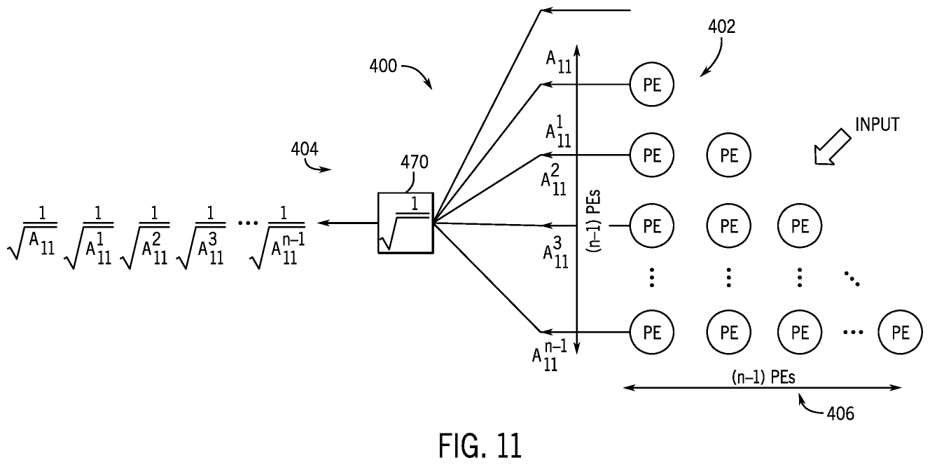

Turning now to FIG. 11, the figure is a schematic diagram illustrating and embodiment of the CMAC cell array 400 showing outputs from the edge 406 being used as inputs into Part II (block 306) processing. More specifically, outputs from the CMAC cell array 400 representative of A₁₁, A₁₁¹, A₁₁², A₁₁³, . . . A₁₁ⁿ⁻¹ may then be directed as input into a square root pipeline system 470. The square root pipeline system 470 may then use the input to generate square root calculations of A_{1,1}^{k} (k=0, . . . , n−1), e.g.,

$$\frac{1}{\sqrt{{A}_{11}}} \frac{1}{\sqrt{{A}_{11}^{1}}} \frac{1}{\sqrt{{A}_{11}^{2}}} \frac{1}{\sqrt{{A}_{11}^{3}}} … \frac{1}{\sqrt{{A}_{11}^{n - 1}}} .$$

The calculations may then be used in Part III (block 308). As mentioned earlier, it may be possible to pipeline the CMAC cell array 400 and subsequent systems downstream (or upstream) of the CMAC cell array 400 so that data flows may stream through the pipelines, which may improve throughput and efficiency.

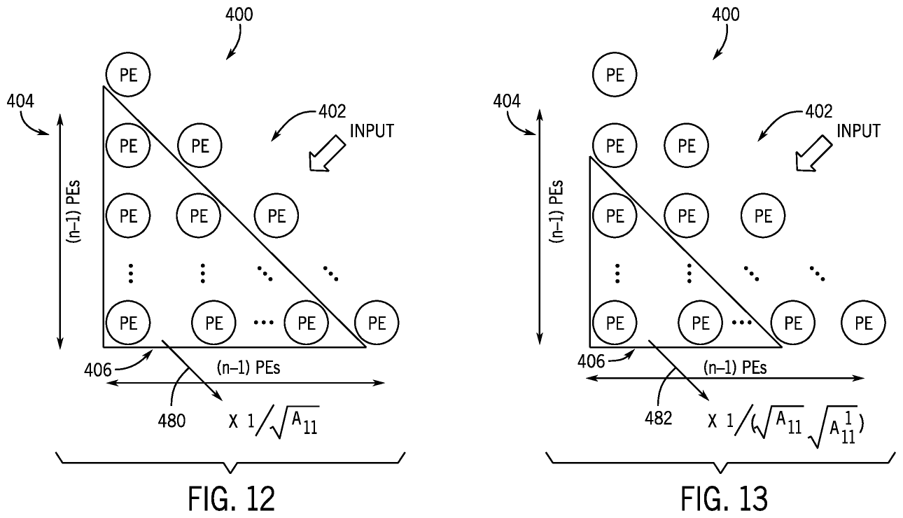

FIGS. 12-14 are a schematic diagrams illustrating embodiments of the CMAC cell array 400 as Part III (block 308) derivations may be executed via subarrays. For example, FIG. 12 illustrates an embodiment of the CMAC cell array 400 where a subset 480 of the PEs output data representative of a first output iteration through the CMAC cell array 400. A first data output may thus include \sqrt{A₁₁}, which may then be used to derive 1\sqrt{A₁₁}, (e.g., 1 divided by denominator output).

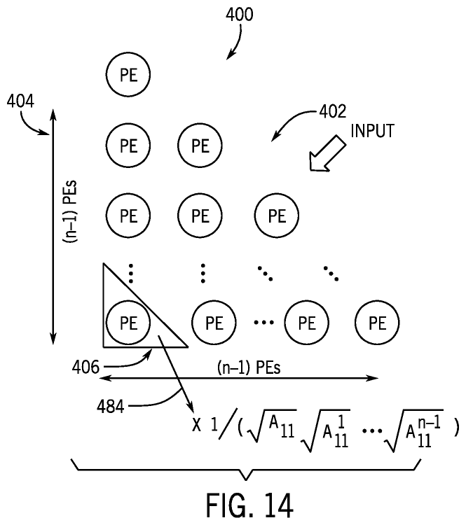

FIG. 13 illustrates an embodiment of the CMAC cell array 400 where a subset 482 of the PEs output data representative of a second output iteration. The second output iteration may include \sqrt{A₁₁¹}, which may then be used to derive 1/(\sqrt{A₁₁}\sqrt{A₁₁¹}). Likewise, FIG. 14 illustrates an embodiment of the CMAC cell array 400 where a subset 484 of the PEs (e.g., single PE) output data representative of an nth output iteration. The nth output iteration may include (\sqrt{A₁₁ⁿ⁻¹}), which may then be used to derive 1/(\sqrt{A₁₁}\sqrt{A₁₁¹} . . . \sqrt{A₁₁ⁿ⁻¹}). 1 divided by the denominator may be computed after each iteration, after all numerator are computed, between some iterations, or a combination thereof. By applying the CMAC cell array 400 for Part I (block 304) derivations, Part II (block 306), and/or Part III (block 308) derivations, the techniques described herein may provide for systolic array processing for more efficient Cholesky decompositions.

It is to be noted that entries of the Hermitian positive-definite matrix A may include digital signal processing (DSP) signals. For example, the signals may include data sampled over a time domain, a space domain, or both. Accordingly, the entries may be used as input to the CMAC cell array 400 described above. Further, the algorithms described herein, including process 300 may be implemented as computer code or instructions executable by the CMAC cell array 400, via processors, such as via the processor 102, via FPGAs, and/or via ASICs. Indeed, the techniques described herein, such as the process 300, may now be more easily implemented in a variety of computing systems.

While the embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims.

What is claimed is:

1. A system, comprising:
a circuitry comprising a plurality of processing elements (PEs), the circuitry configured to:
receive as input entries of a Hermitian positive-definite matrix A;
Cholesky decompose the matrix A by deriving an intermediate numerator for at least one of the entries;
calculate a square root for the intermediate numerator; and
derive as an output an entry of a lower triangular matrix L based on the square root, wherein A=LL*, and wherein L* is a conjugate transpose of the lower triangular matrix L.

2. The system of claim 1, wherein the circuitry comprises a systolic array having the plurality of PEs, the systolic array comprising a first edge of PEs configured to receive the input entries and a second edge of the PEs to provide the output.

3. The system of claim 2, wherein the systolic array comprises a triangular array having the first edge, the second edge, and third edge of PEs, wherein the first edge, the second edge, and the third edge of PEs each comprises a total of n−1 PEs and wherein the matrix A comprises n×n entries.

4. The system of claim 3, wherein inputs into the triangular array are received in an alternate order, via the first edge, the second edge, the third edge, or a combination thereof.

5. The system of claim 4, wherein the alternate order comprises a diagonal pattern followed by a column pattern, or the column pattern followed by the diagonal pattern.

6. The system of claim 2, wherein the systolic array comprises a complex-valued multiply-accumulate (CMAC) cell array.

7. The system of claim 1, wherein the intermediate numerator comprises A_{i,j}^{k} as the numerator of an entry at row i and column j of a deflated matrix of matrix A in a k-th iteration.

8. The system of claim 7, wherein deriving the intermediate numerator comprises deriving A_{i-1,j-1}^{k+1}←A_{1,1}^{k}A_{i,j}^{k}−A_{i,1}^{k}A_{j,1}^{k*}.

9. The system of claim 8, wherein the entry of the lower triangular matrix L comprises L_{i,j} where L_{i,j}←A_{i-j+1,1}^{j-1}/Πₖ₌₀^{j-1}\sqrt{A_{1,1}^{k}}.

10. The system of claim 1, wherein the input entries are representative of digital signal processing (DSP) signals comprising samples of a continuous variable in a time domain, a space domain, or a combination thereof.

11. A method, comprising:
receiving, via a circuitry, input entries of a Hermitian positive-definite matrix A;
performing a Cholesky decomposition, via the circuitry, by deriving an intermediate numerator for at least one of the entries;
deriving, via the circuitry, a first intermediate numerator for at least one of the entries;
calculating a square root for the first intermediate numerator; and
deriving a first output comprising a first entry of a lower triangular matrix L based on the square root, wherein A=LL*, and wherein L* is a conjugate transpose of the lower triangular matrix L.

12. The method of claim 11, comprising deriving, via the circuitry, a second intermediate numerator in parallel with calculating the square root for the first intermediate numerator.

13. The method of claim 12, comprising deriving, a second output comprising a second entry of the lower triangular matrix L in parallel with calculating the square

14. The method of claim 11, wherein receiving, via the circuitry, the input entries comprises receiving the input entries in a diagonal pattern followed by a column pattern, or in the column pattern followed by the diagonal pattern.

15. The method of claim 11, wherein the first intermediate numerator comprises A_{i,j}^{k} as the numerator of an entry at row i and column j of a deflated matrix of matrix A in a k-th iteration, and wherein deriving the first intermediate numerator comprises deriving A_{i-1,j-1}^{k+1}←A_{1,1}^{k}A_{i,j}^{k}−A_{i,1}^{k}A_{j,1}^{k*}.

16. A non-transitory, computer readable medium having stored thereon software instructions that, when executed by circuitry, cause the circuitry to:
receive input entries of a Hermitian positive-definite matrix A;
perform a Cholesky decomposition by deriving an intermediate numerator for at least one of the entries;
derive an intermediate numerator for at least one of the entries;
calculate a square root for the intermediate numerator; and
derive a first output comprising a first entry of a lower triangular matrix L based on the square root, wherein A=LL*, and wherein L* is a conjugate transpose of the lower triangular matrix L.

17. The non-transitory, computer readable medium of claim 16, wherein the intermediate numerator comprises A_{i,j}^{k} as the numerator of an entry at row i and column j of a deflated matrix of matrix A in a k-th iteration.

18. The non-transitory, computer readable medium of claim 17, wherein deriving the intermediate numerator comprises deriving A_{i-1,j-1}^{k+1}←A_{1,1}^{k}A_{i,j}^{k}−A_{i,1}^{k}A_{j,1}^{k*}.

19. The non-transitory, computer readable medium of claim 18, wherein the entry of the lower triangular matrix L comprises L_{i,j} where L_{i,j}←A_{i-j+1,1}^{j-1}/Πₖ₌₀^{j-1}\sqrt{A_{1,1}^{k}}.

20. The non-transitory, computer readable medium of claim 16, wherein the circuitry comprises a processor, a plurality of processing elements (PEs), or a combination thereof.
